(19) United States
(12) Patent Application Publication
(10) Pub. No.: US 2004/0145094 A1
(43) Pub. Date: Jul. 29, 2004

(54) Method of making a composite molded article

(75) Inventors: Robert P. McCollum, Transfer, PA (US); Shiraz Sidi, Hermitage, PA (US); Jeffrey J. O'Hara, Sharon, PA (US); Richard Eugene Clark, Osceola, IN (US)

Correspondence Address: MERCHANT & GOULD PC, P.O. BOX 2903, MINNEAPOLIS, MN, 55402-0903, US

(73) Assignees: VEC Technology, Inc., Greenville, PA (US); Kinro, Inc., Arlington, TX (US)

(21) Appl. No.: 10/408,965

(22) Filed: Apr. 8, 2003

Related U.S. Application Data
(63) Continuation of application No. 10/351,254, filed on Jan. 24, 2003.

(51) Int. Cl. B29C 70/48

(52) U.S. Cl. 264/544; 264/236; 264/316; 264/258

(57) ABSTRACT

The invention relates to the formation of a smooth attractive surface on a composite molded article. More particularly, the invention relates to combining materials in a mold to result in a composite article having a finished surface. The invention relates to a method having improved efficiency and reduced emissions of hazardous air pollutants used in making composite molded articles comprising a reinforced thermosetting material having a thermoplastic exterior layer.

### FIELD OF THE INVENTION

The invention relates to the formation of a smooth attractive surface on a composite molded article. More particularly, the invention relates to combining materials in a mold to result in a composite article having a finished surface. The invention relates to a method having improved efficiency and reduced emissions of hazardous air pollutants used in making composite molded articles comprising a reinforced thermosetting material having a thermoplastic exterior layer.

### BACKGROUND OF THE INVENTION

The invention relates to the manufacture of composite molded articles using closed mold processing. More particularly, the invention relates to an improved method for making a thermoset article having a fiber reinforced structure and an attractive thermoplastic exterior layer.

Composite structures comprising a fibrous reinforcing material impregnated with a cured, thermoset resin are known for manufacturing articles such as spas, tubs, recreational vehicles, auto body panels and marine components such as boat decks and hulls, for example. A composite article commonly has an external layer to provide a smooth, attractive appearance. Materials selected for the exterior surface of the composite require a combination of desirable properties including outdoor weatherability, impact resistance, attractive cosmetic qualities and ease of processing.

Conventional methods for making fiber reinforced composite structures involve manually shaping the reinforcing fiber to a mold surface and then impregnating the fiber with a thermoset resin. Typically, a gel coat of clear or pigmented thermoset resin is applied to the surface of the mold before forming a final laminate structure. The gel coat results in a cosmetically attractive surface for the finished article and protects the fiber composite from attack by ultra violet radiation from the sun. However, layers made from gel coat materials tend to develop crazing, cracks and color fading over time. Cracks can range from cosmetic hairline cracks to cracks that extend into the laminate resulting in structural defects. Even hairline cracks need to be repaired to prevent greater structural damage from developing. Repairs can be expensive and the original color of the gel coat is virtually impossible to match.

Gel coats are typically applied to the mold surface by spray methods in which the material in thickened liquid form is placed on the mold surface. The gel coat material contains volatile organic components (VOCs) such as styrene monomer that is released to the ambient environment. Many of these volatile components are classified as hazardous air pollutants that are harmful to human health and the environment. Further, VOCs are often flammable resulting in a fire hazard. Elaborate precautions and expensive equipment is required to minimize the release of and exposure to these volatile substances.

An alternative to a thermoset resin gel coat is a thermoplastic sheet on the exterior surface of the composite. Thermoplastic sheet s have better weatherability and more flexibility than thermoset plastics and have less tendency to form cracks. The sheet may be shaped by thermoforming methods and then reinforced with fiberglass composite backing. For example, Russell, U.S. Pat. No. 4,178,406 discloses a method for making a fiberglass-reinforced article wherein a preformed thermoplastic film is placed in a holding fixture, a reinforcing fibrous material and curable thermoset resin layer are applied to the film and finally, a second preformed thermoplastic film is applied to the reinforcing layer. The composite is then subjected, in a thermoforming process, to a vacuum to form the shaped article. The film is in the form of a sheet having an average thickness of 40 mils. Such thin materials can be difficult to handle and are easily wrinkled resulting in an unsightly appearance and uneven bonding between the film and the reinforcing layer.

Rigid, thermoformable panels comprising an acrylic film laminated to a thermoformable substrate provide improved handling properties. Representative panels are described in Rutledge, U.S. Pat. No. 4,221,836, Goldsworthy, U.S. Pat. No. 4,498,941 and Hicks et al., U.S. Pat. No. 5,069,851. The rigid panels can be shaped by thermoforming methods well known in the art and reinforced with a composite thermoset resin and fiberglass backing. Combining the fiberglass reinforced polyester resin with the individual thermoformed product is generally performed manually outside the thermoforming mold in a slow, labor intensive process. Such a method results in undesirable emission of hazardous air pollutants during application.

There is a continuing need to improve the production rate of shaped laminated composite articles, to reduce labor costs and to control the emission of hazardous air pollutants.

### SUMMARY OF THE INVENTION

The invention provides a method with improved efficiency and reduced emissions of hazardous air pollutants for making composite molded articles comprising a thermoplastic sheet with reinforcement. The method involves placing the thermosetting materials, fiber reinforcement and the thermoplastic sheet between opposed apart mold halves to form a laminate. The mold halves have complimentary mold surfaces. When the two mold halves are assembled with their respective molding surfaces in opposition to one another, a mold plenum is defined within which to fabricate the desired article. The thermoplastic sheet is preformed to a desired shape substantially conforming to the shape of the mold surfaces particularly the exterior mold surface. The thermoplastic sheet and the mold surfaces have complimentary shapes so that the thermoplastic sheet can be positioned between the mold halves and allow the mold halves to be brought together to define the mold plenum with little or no modification or distortion of the mold surface. Fibrous reinforcement material is placed on the thermoplastic sheet. The opposed apart mold halves are brought together to form the mold plenum. Molding fluid is injected into the mold plenum to impregnate the fibrous reinforcement material. The mold plenum is a substantially closed system that prevents escape of volatile organic substances from the molding fluid to the atmosphere. The molding fluid is cured to form a rigid composite molded article. All the thermosetting material is reacted and forms a solid reinforced composite structure leaving little volatile material. The thermoplastic sheet is formed as the external layer of the composite structure.

In another embodiment, first and second mold halves having complimentary molding surfaces are assembled with their respective molding surfaces in opposition to one another. When the mold halves are brought together, a mold plenum is formed within which to fabricate a desired article. Fibrous reinforcement material is placed on the mold surface of one of the first or second mold halves. A thermoplastic sheet having a shape substantially conforming to the shape of the mold plenum is placed on the reinforcement material. The mold halves are brought together forming a mold plenum and molding fluid is injected into the mold plenum to impregnate the reinforcement material. The molding fluid is cured to form a rigid composite molded article with the thermoplastic sheet on the exterior of the article structure.

In another embodiment, a thermoplastic sheet is placed between opposed apart mold halves. The mold halves have complementary molding surfaces such that the mold surfaces form a mold plenum when the mold halves are brought together. The thermoplastic sheet may be softened before placing the sheet between the mold halves. Alternatively, the mold surfaces may by heated to a temperature sufficient to soften the thermoplastic sheet. The mold halves are closed together and the thermoplastic sheet is shaped to conform to the shape of the mold surfaces. The mold halves are separated and fibrous reinforcement material is placed on one surface of the shaped thermoplastic sheet. The mold halves are again brought together to form a mold plenum and molding fluid is injected into the mold plenum to impregnate the fibrous material. The molding fluid is cured to form a rigid laminated composite molded article with the thermoplastic sheet on the exterior of the article.

In another embodiment, a thermoplastic sheet is placed between opposed apart mold halves. The mold halves have complementary molding surfaces such that the mold surfaces form a mold plenum when the mold halves are brought together. The thermoplastic sheet may be softened before placing the sheet between the mold halves. The molding surface in contact with the thermoplastic sheet is provided with vacuum ports for applying a vacuum to shape the softened thermoplastic sheet to the mold surface. This embodiment avoids the need to close the mold halves to shape the thermoplastic sheet. After shaping the thermoplastic sheet, fibrous reinforcement material is placed on the surface of the shaped thermoplastic sheet. The mold halves are brought together to form a mold plenum and molding fluid is injected into the mold plenum to impregnate the fibrous material. The molding fluid is cured to form a rigid laminated composite molded article with the thermoplastic sheet on the exterior of the article.

In still another embodiment, first and second mold halves having complimentary molding surfaces are assembled with their respective mold surfaces in opposition to one another. When the mold halves are closed together, a mold plenum is formed within which to fabricate a desired article. A first thermoplastic sheet is preformed to a desired shape to substantially conform to the shape of the mold surfaces. The thermoplastic sheet and the mold surfaces have complimentary shapes so that the thermoplastic sheet can be positioned between the mold halves and allow the mold halves to be brought together to define the mold plenum. The first thermoplastic sheet is placed between opposed apart mold surfaces and fibrous reinforcement material is placed on the thermoplastic sheet. A second thermoplastic sheet having a shape complementary to the first thermoplastic sheet is placed in contact with the reinforcement material. A layered structure is formed comprising a first thermoplastic sheet, a reinforcement material and a second thermoplastic sheet. The mold halves are brought together to form the mold plenum. Molding fluid is injected into the mold plenum to impregnate the reinforcement material. The molding fluid is cured to form a rigid composite article having the thermoplastic sheet as an interior surface and an exterior surface.

Composite articles such as tubs and shower surrounds have very high cosmetic requirements for visible surfaces. The molding surface of a closed mold membrane may have minor flaws that would not be objectionable for many molding applications, but would adversely affect the cosmetic appearance of a tub. It is desirable that the cosmetic surface of the molded article does not come in direct contact the surface of the mold membrane. The cosmetic surface of such articles may be accommodated in the closed mold by inserting a soft liner between the mold membrane surface and the cosmetic surface of the thermoplastic sheet. Liner material may have single or multiple layers. Examples of suitable soft liner materials include felt or a composite of plastic film laminated to sponge backing. Typically, the liner material is pattern cut to cover the mold membrane and is affixed to the surface of the membrane with adhesive. A soft liner also accommodates slight variations in the dimensions of the shaped thermoplastic sheet that may occur during the thermoforming process. For example, softening and hardening of a thermoplastic may result in some dimensional shrinkage. If the cooling rate of the thermoformed sheet varies, it may cause slight shrinkage of the sheet that cannot be easily controlled. Shrinkage adversely affects the ability of the sheet to conform closely to the shape of the mold membrane. A soft liner compensates for small differences in the dimensions of the thermoformed sheet and the mold membrane.

Other embodiments of these processes can be used without departing from the processes of the invention.

### BRIEF DESCRIPTION OF THE DRAWINGS

FIG. 1 is a partial cross section of a molding apparatus showing a shaped thermoplastic sheet between male and female mold halves.

FIG. 2 is a partial cross section of a molding apparatus showing a shaped thermoplastic sheet positioned in a female mold half with fiber reinforcement material.

FIG. 3 is a partial cross section of a molding apparatus showing male and female mold halves closed about a shaped thermoplastic sheet to form a mold plenum.

FIG. 4 is a partial cross section of a molding apparatus showing reinforcement material positioned in a female mold half with fiber reinforcement material.

FIG. 5 is a partial cross section of a molding apparatus showing a thermoplastic sheet positioned between a male and a female mold half.

FIG. 6 is a partial cross section of a molding apparatus showing a shaped thermoplastic sheet positioned in a female mold half with fiber reinforcement material.

FIG. 7 is a partial cross section of a closed molding apparatus having a mold plenum showing a shaped thermoplastic sheet with fiber reinforcement material positioned in the plenum.

FIG. 8 is a partial cross section of a molding apparatus showing two shaped thermoplastic sheets with reinforcement material therebetween.

FIG. 9 is a partial cross section of a closed molding apparatus having a mold plenum showing two shaped thermoplastic sheets with fiber reinforcement material positioned in the plenum.

FIG. 10 is a partial cross section of a mold half with vacuum ports.

FIG. 11 is a partial cross section of another embodiment of the invention showing a soft liner between the surface of a mold membrane and a cosmetic surface of a thermoplastic sheet.

### DETAILED DESCRIPTION OF THE INVENTION

The methods of the invention involve placing a thermoplastic sheet, a fiber reinforcement material and a molding fluid in a mold to form a composite structural unit.

The composite material also comprises a fiber reinforcement or a filament reinforcement material. Such materials typically comprise a woven or non-woven sheet made up of fiber portions or filament materials. The woven or non-woven material can be formed from the fibers or can be impregnated or combined with other coatings or resins in the woven or non-woven sheet. A variety of natural or synthetic fibers can be used in the reinforcement layer. Natural fibers can include cotton, flax, jute, knaff and other fibers derived from natural sources understood by one of ordinary skill in the art. Similarly, synthetic fibers can include polyolefin fibers, polyester fibers, polyamide fibers, and other such thermoplastic or thermosetting fiber materials. Further, other types of fibers can include glass fiber reinforcement materials, carbon fiber reinforcement materials, or other specialty fibers such as boron fibers, etc.

The product and process of the invention uses a thermoplastic sheet as an interior or exterior surface layer that provides a decorative or cosmetic appearance to the structure. The thermoplastic layer has the benefit that it is easily included into the laminate thermoset structure, and avoids the problems inherent in gel coat formation. Thermoplastic sheets useful in the invention include sheets having a thickness of about 0.5 mm to 15 mm, a softening point of about 200° F. to 400° F. and are manufactured in the form of large rectangular sheets or in roll form that can be applied to the molding processes of the invention. The thermoplastic sheets must be easily handleable and useful in premold operations and in the molding operations of the invention. An important aspect of the thermoplastic sheet is that it can be placed into a thermal forming mold that can achieve the general overall shape of the finishing mold. The premolded shape is preferably formed into a structure having little or no bubbles, folds, sags, or other distortion of the smooth surface of the thermoplastic sheet. Such surface flaws are avoided when forming the final article to provide a smooth uniform surface that, to the eye, has a uniform color density.

The thermoplastic sheet may be in the form of cut-sheet stock, roll-fed stock or directly extruded to the thermoforming mold. The thickness of the thermoplastic sheet may range from about 0.5 mm to about 15 mm. Roll-fed stock or direct extrusion thermoforming is generally limited to a sheet thickness less than about 3 mm. One skilled in the art will select sheet thickness based upon finished part requirements. Exemplary thermoplastic materials include sheets made from ABS, PVC, acrylonitrile-styrene-acrylate (ASA), acrylate-ethylene-styrene (AES), polystyrene, polycarbonates, nylon, polyacrylates, polymethacrylates, acrylate/methacrylate copolymers, polyethylene, polypropylene, and thermoplastic elastomers and elastomer blends. Further, the thermoplastic sheets may be combinations of thermoplastic materials such as alloys or laminates. Exemplary materials include acrylic sheet sold under the trade designation ACRYLSTEEL M and acrylic/ABS laminate sheet sold under the trade name ALTAIR PLUS both commercially available from Aristech Acrylics LLC, Florence Ky. The acrylic portion of the acrylic/ABS laminate provides a cosmetically attractive exterior surface. Other suitable sheet material include ASA and AES sheet sold under the trade name CENTREX, ABS sheet sold under the trade name LUSTRAN, and polycarbonate sheet sold under the trade name MAKROLON all of which are commercially available from Bayer Corp., Pittsburgh, Pa. Thermoplastic polyolefin sheet having product designation HDPE SP, LDPE SP, HIPS SP are commercially available from SPARTECH Corp., Clayton, Mo. These sheet materials are supplied in various grades and a person skilled in the art understands how to select a grade appropriate to achieve the desired characteristics of the fabricated article.

In general, the process of the invention involves forming a fiber reinforced thermoplastic article having either an interior or exterior surface layer formed from a thermoplastic sheet having a visible cosmetically attractive layer. An appropriately sized thermoplastic sheet is introduced into a preform thermal forming mold in order to obtain a shape that conforms to the mold shape of the final thermo setting structure. The thermoplastic sheet material can be warmed in order to ease formation of the structure or shape in the premold step. The thermoforming mold can also be warmed or heated to an appropriate temperature to efficiently introduce the shape into the thermoplastic sheet. A temperature for pre-molding is carefully selected to match a temperature useful with the thermoplastic sheet. In some instances, the temperature used is greater than the softening point of the thermoplastic sheet. Generally, for thermoplastic sheets, the premold step is conducted at a temperature from about 250° F. to about 350° F. The thermoplastic sheet can also be directly introduced into the mold for forming the composite article without pre-forming. If the sheet is not pre-formed, the sheet can be warmed to a temperature above its heat deflection temperature prior to introduction into the mold. Heat deflection temperature may be determined according to ASTM D-648 method and is commonly specified by suppliers of sheet material.

Suitable molding fluids include thermoset resins well known to those skilled in the art and include polyester, vinyl esters, acrylic polymers, polyepoxides, aminoplasts, alkyd resins, polyamides, polyolefins, polyurethanes, vinyl polymers and phenolic resins and mixtures thereof capable of undergoing an irreversible, chemical crosslinking reaction. Non-limiting examples of useful polyester materials include RD-847A polyester resin commercially available from Borden Chemicals of Columbus Ohio, STYPOL polyester resins commercially available from Cook Composites and Polymers of Port Washington WS, POLYLITE polyester resins with styrene commercially available from Reichold Inc. of Durham, N.C. and NEOXIL polyesters commercially available from DSM B.V. of Como, Italy. Various additives may be incorporated into the resin including curing catalysts, viscosity modifying agents, mold release agents, fillers, pigments, opacifiers and the like. Viscosity modifying agents may include Group II metal oxides or hydroxides and crystalline, hydrogen saturated polyesters.

Useful resin includes the following formulations:

| | Parts by weight per each 100 |
|---|---|
| | parts of resin |
| Unsaturated polyester resin | 100 |
| unsaturated vinyl resin | 0-100 |
| styrene | 0-100 |
| Divalent metal; preferably a Cobalt mixed | 0.1-10 |
| carboxylate (6% in mineral spirits) | |
| toludine compound | 0.1-10 |
| acetyl acetamide compound | 0.1-10 |
| Mixed silicone wetting agent/deaerator | 0.1-10 |
| Vegetable Oil | 0.1-10 |
| Plastic microspheres | 0.1-10 |
| Inorganic filler, (CaCO₃, Al₂O₃ hydrate) | 5-30 |
| Pigment (Black) | 0.1-10 |
| Pigment (White) | 0.1-10 |
| Alkyl catechol compound | 0.001-0.1 |

The composite molding apparatus for carrying out the invention is characterized by using replaceable and reusable mold membranes or skins. Replaceable mold membranes provide an inexpensive and easily replaced mold surface for making composite articles having different shapes or simply to replace a worn surface. A molding apparatus for carrying out the invention is described in McCollum et al., U.S. Pat. Nos. 5,971,742, 6,143,215 and 6,257,867, each expressly incorporated herein by reference for teachings relating to the injection molding apparatus, thermosetting materials and process conditions. In the description that follows, the same reference numeral is used for the same part illustrated throughout the figures showing views and embodiments of the invention.

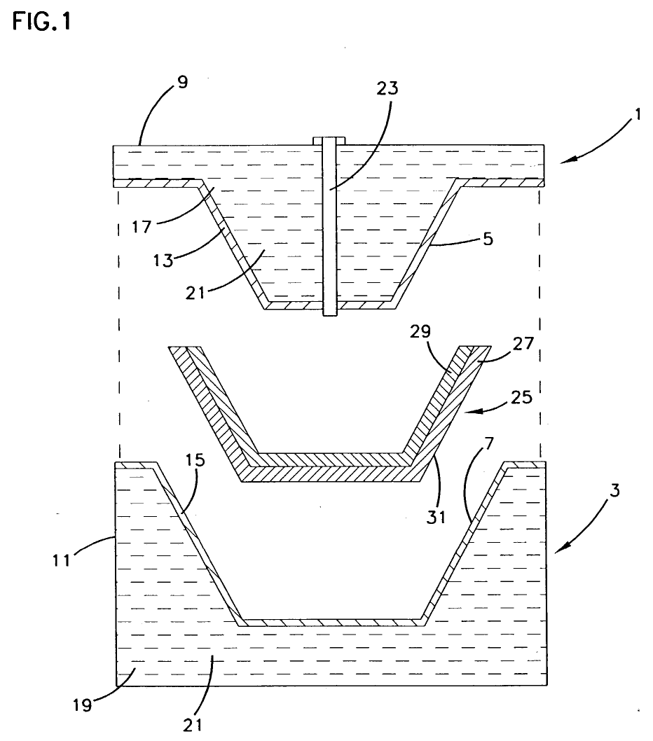

In part, the molding apparatus comprises of a pair of mold halves in an opposed apart relationship. FIG. 1 shows a first mold half 1 and a second mold half 3 forming a pair of opposed mold halves 1, 3 in cross section. The mold halves are assembled with their respective mold surfaces 5, 7 in opposition to one another to define a mold plenum within which to fabricate the desired composite article. Each mold half includes a rigid housing 9, 11 and a membrane 13, 15 removably mounted to the rigid housing to form a fluid tight chamber 17, 19. The membranes may be made from fiberglass composite, reinforced nylon, sheet metal or other suitable materials that may be conveniently and cheaply fabricated, shaped and reshaped in a manner known to those skilled in the art. The membranes of each mold half may be of the same or different material. Further, the membranes may be flexible, and are supported during the molding step by a backing fluid 21 to ensure proper dimensioning of the finished article.

Each fluid tight chamber 17, 19 is completely filled with a non-compressible, heat conductive backing fluid 21. The fluid 21 supports the membranes 13, 15 and evenly distributes any injection pressure loading across its entire surface. Since the backing fluid 21 is non-compressible, any force exerted on the membranes 13, 15 will be transferred through the fluid to the walls of the rigid housings 9, 11. Backing fluids include inorganic liquids such as water and organic liquids such as polyglycols and polysilicones. Selection of backing fluid will depend on molding variables such as temperature and pressure. For example, those skilled in the art understand that a backing fluid with a higher vaporization temperature and thermal stability is preferred as the operating temperature of the mold increases.

The mold half 1 may include one or more injection sprues 23 extending through the mold half 1 to provide a pathway through which a desired molding fluid may be injected under pressure into the mold plenum. The opposing mold half may also include one or more sprues. The number and placement of sprues depends upon the configuration and desired characteristics of the article to be molded and the flow characteristics of the molding fluid employed in a manner understood by one skilled in the art.

In accordance with the present invention, a thermoplastic sheet 25 is shaped by thermoforming using a master mold. Thermoforming methods for shaping thermoplastic sheets are well known and are understood by one skilled in the art. Thermoforming conditions such as heating rate, forming temperature and cooling rate may vary with the properties of the particular sheet material being shaped. For example, the sheet may be shaped in a vacuum forming step wherein the sheet is softened by heating, placed on the master mold and then shaped by applying a vacuum to the softened sheet to conform the sheet to the shape of the master mold. The master mold may provide a male or female molding surface. A shape is chosen for the master mold so that the shape of the molded thermoplastic sheet is complementary to the shape of the mold membranes of the injection molding apparatus. The shaped sheet fits within and substantially conforms to the shape of the mold plenum defined by the mold halves. The mold membranes 13, 15 likewise have male and female molding surfaces. The female features of the shaped thermoplastic sheet are complimentary to the male features of the mold membranes.

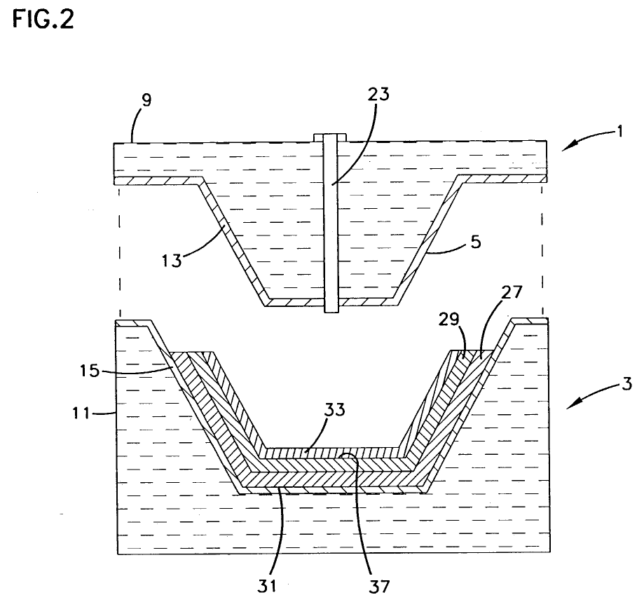

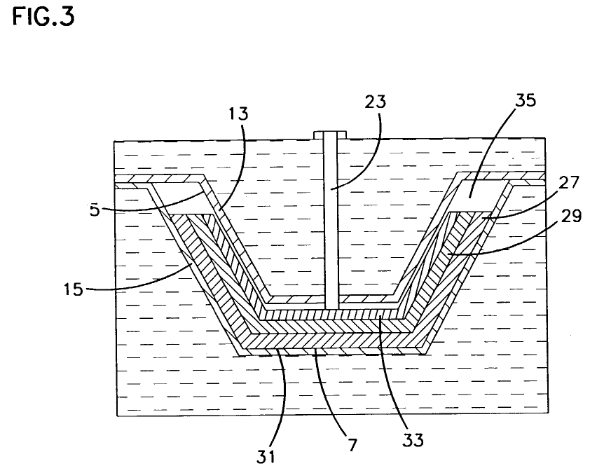

The thermoplastic sheet 25 may have a cosmetically attractive surface 31 and the cosmetically attractive surface 31 is intended to be the exterior surface of finished composite object. The composition of the thermoplastic sheet may be the same throughout or may be a laminate comprising a film 27 on a rigid support 29. For example, the film 27 may be acrylic and the rigid support 29 mat be ABS. As shown in FIGS. 2 and 3, when the sheet 25 is place in the mold, the cosmetic surface 31 is proximate the surface of the mold membrane and reinforcement material 33 is placed opposite the cosmetically attractive surface 31. In embodiments described below, the placement of sheet 25 and reinforcement material 33 on the mold membrane may be reversed. The reinforcement material may be proximate the surface of the mold membrane and the sheet positioned on the reinforcement material. The particular arrangement of thermoplastic sheet and reinforcement material in the injection molding apparatus is determined so that the cosmetically attractive surface of the sheet is the exterior or visible surface of the finished composite article.

The thermoplastic sheet 25 may be a single thermoplastic polymer, a blend or alloy of two or more thermoplastic polymers, a laminate of two or more thermoplastic polymers or a laminate having a foam core, such as a polyurethane foam having thermoplastic sheet material affixed to one or both sides of the foam core. A thermoplastic laminate may have a surface comprising a cosmetically attractive film 27 combined with a high impact thermoplastic substrate 29 for strength. Referring to FIGS. 1-2, the mold halves 1, 3 are positioned in an open, opposed apart relationship for receiving a shaped thermoplastic sheet 25. The shaped thermoplastic sheet 25 is placed between the mold halves 1, 3 so that the shape of the thermoplastic sheet 25 conforms to the shape of the mold membranes 13, 15 to allow the mold halves 1, 3 to be brought together to a closed position. FIG. 2 shows the shaped thermoplastic sheet 25 positioned on the mold membrane 15. Fiber reinforcement material 33 is placed on the surface 37 opposite the cosmetically attractive surface 31 of the shaped thermoplastic sheet 7. The fiber reinforcement material 33 may be filamentary woven, non-woven or stitched manmade or natural fiber and may be preformed mat of chopped strand or continuous strand. Suitable fibers include fiberglass, nylon, polyester, hemp, knaff and the like. Referring to FIG. 3, the mold halves 1, 3 are brought together to form the mold plenum 35. The fiber reinforcement material 33 may be placed in contact with the thermoplastic sheet 25 before the thermoplastic sheet 25 is placed in contact with the mold membrane 15 without deviating from the inventive concept.

The temperature of the backing fluid 21 may be varied to optimize the cure rate of the particular molding fluid being used. Typically, the temperature of the backing fluid 21 is 80° F. to 200° F. Further, the temperature of the backing fluid 21 in each mold half 1, 3 may be the same or different and can be selected empirically based on the properties of the sheet material and the molding fluid. After the mold halves 1, 3 are brought together to form a mold plenum 35, the desired molding fluid is injected into the mold plenum 35 through the injection sprue 23. The injection rate can be varied by varying the temperature of the molding fluid. The temperature of the molding fluid is typically in the range of 70° F. to 150° F. and the injection rate is typically 25 to 50 pounds of molding fluid per minute. The optimal injection rate is easily determined based upon factors well known to those skilled in the art. Once the mold plenum is completely filled with molding fluid the injection ceases. Whether the plenum is completely filled can be determined by means described in the U.S. patents referred to above. These include visual observation of discharge of excess molding fluid through air bleeds (not shown) or pressure sensors (not shown) within the mold halves to sense pressure changes during injection of molding fluid. A relatively sharp increase of injection pressure indicates that the mold plenum 35 is filled. The temperature of each molding surface 5, 7 can be regulated to provide an optimum cure rate with which to obtain the desired properties of the finished article or to otherwise optimize the molding process. The curing of the molding fluid is typically an exothermic process and curing is allowed to continue until a peak exotherm is observed. The laminated composite molded article is removed from the mold after curing the resin. The article may be removed before the resin is completely cured without departing from the spirit of the invention.

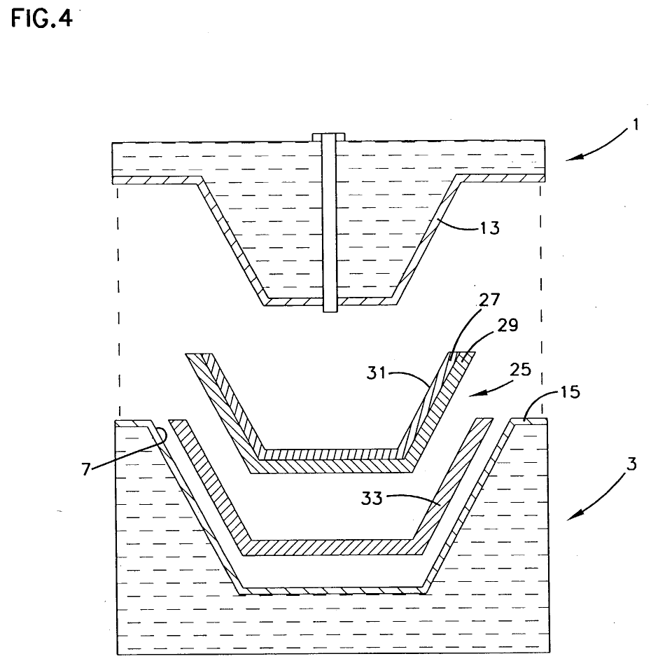

In another embodiment, a pair of mold halves 1, 3 are placed in an opposed apart relationship as described above for the first embodiment. Referring to FIG. 4, reinforcement material 33 is placed in contact with the mold surface 7. A shaped thermoplastic sheet 25 is placed between the mold halves 1, 3 and in contact with the reinforcement material 33. The thermoplastic sheet 25 has a shape that conforms to the shape of the mold membranes 5, 7 to allow the mold halves 1, 3 to be brought together to a closed position forming a mold plenum. The thermoplastic sheet 25 may be a laminate comprising a cosmetically attractive film 27 combined with a high impact thermoplastic substrate 29 providing a cosmetically attractive surface 31. The cosmetically attractive film 27 provides the exterior surface of the composite article. The mold halves 1, 3 are brought together to form a mold plenum. Molding fluid is injected into the plenum to impregnate the reinforcement material. The molding fluid is cured and the composite molded article is removed from the mold.

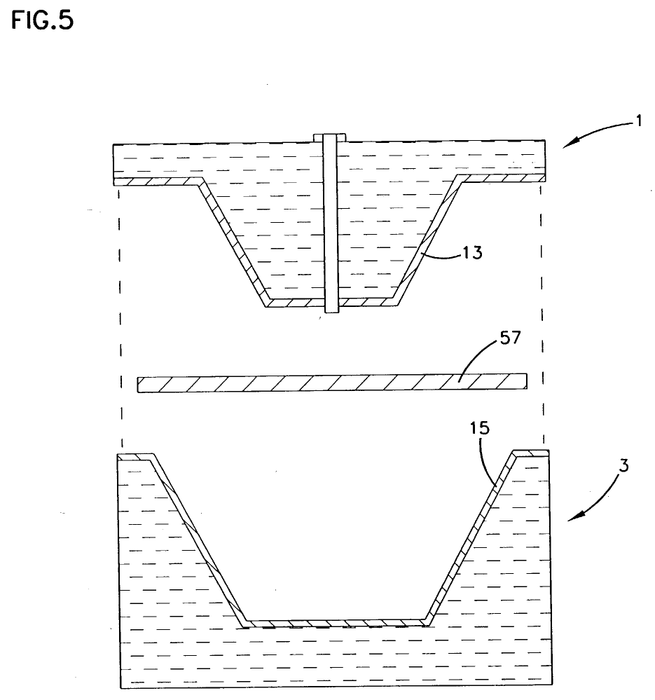

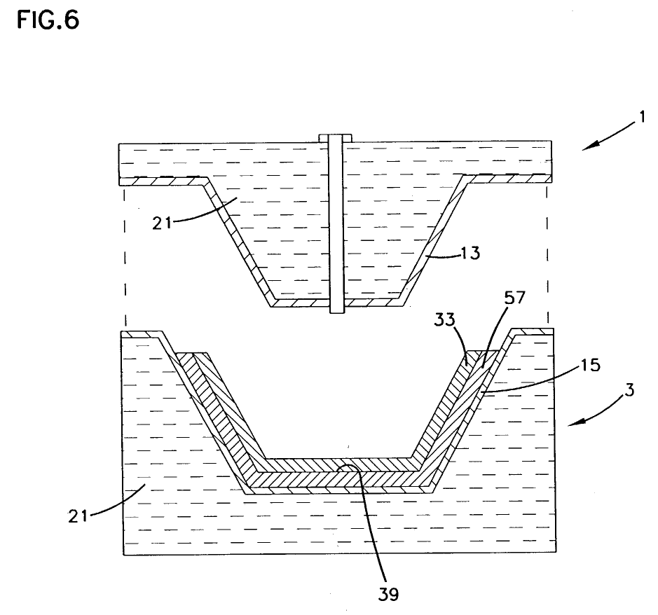

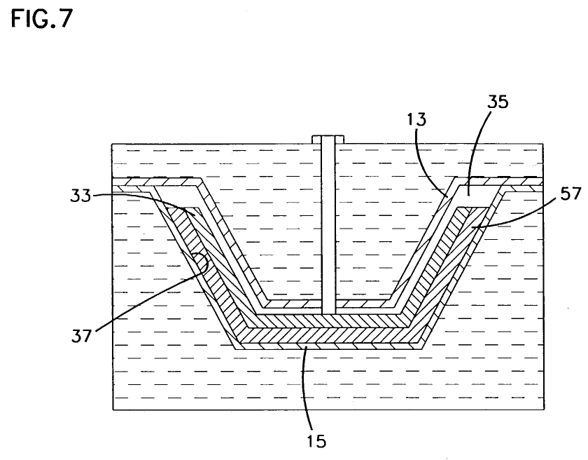

Referring to FIGS. 5-7, in another embodiment, a thermoplastic sheet 57 is placed between the mold halves 1, 3 and the mold halves 1, 3 are brought together to shape the sheet 57 to conform the shape of the mold membranes 13, 15. The thermoplastic sheet 57 may be softened by heating before placing the sheet between the mold halves 1, 3 to facilitate the shaping step. Alternatively, the temperature of the backing fluid 21 may be adjusted to a temperature sufficient to soften the thermoplastic sheet 57 as the mold halves are brought together. The method of softening the thermoplastic sheet 57 is affected by variables such as the thickness, flexibility and softening point of the sheet that are readily ascertained by a person of ordinary skill. Generally, thinner, flexible sheets less than about 5 mm thickness may be softened by heat from the backing fluid 21 as the mold halves 1, 3 are brought together. Sheets thicker than about 5 mm may be softened by hot air, infrared heaters, a heated platen or any conventional method before inserting between the mold halves. The mold halves 1, 3 are separated and reinforcement material 33 is placed on the surface 39 of the shaped thermoplastic sheet 57. The mold halves 1, 3 are again brought together to form a mold plenum 35 and molding fluid is injected into the plenum 35. The molding fluid is cured and the composite molded article is removed from the mold.

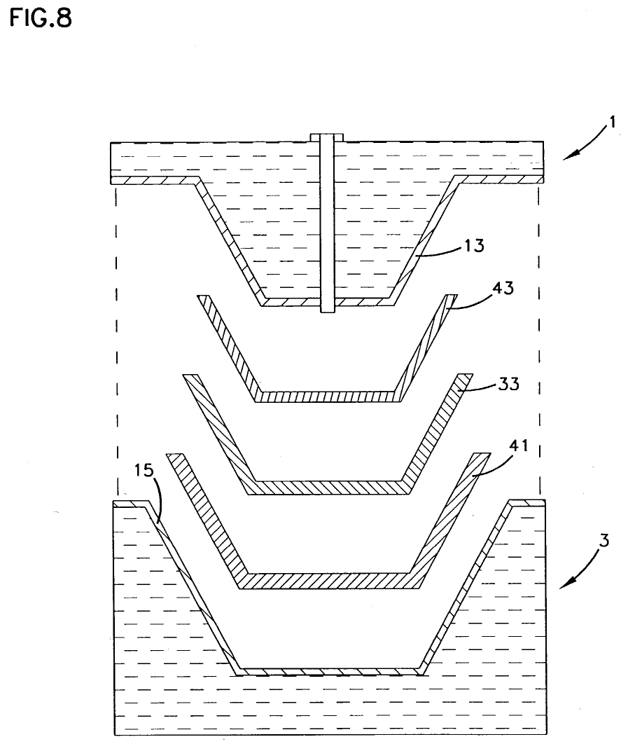

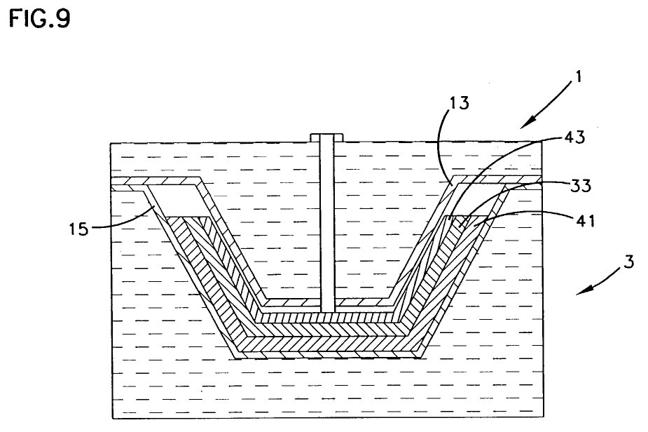

In another embodiment, a composite molded article is formed having reinforcement material sandwiched between a first and a second thermoplastic sheet. Referring to FIGS. 8-9, mold halves 1, 3 are arranged in a spaced apart, opposed relationship. A first thermoplastic sheet 41 is placed in mold half 3. The thermoplastic sheet is shaped to substantially conform to the shape of the mold membrane 15. Reinforcement material 33 is place on the thermoplastic sheet 41. The reinforcement material 33 may be a preform in the shape of the desired article. A second thermoplastic sheet 43 conforming to the shape of the first thermoplastic sheet 41 is placed on the reinforcement material 33. The first and second thermoplastic sheets 41, 43 may be the same or different thermoplastics. For example, if both sides of the finished article can be viewed, it may be desirable for all exterior surfaces to have a cosmetic appearance. Whereas, if only one side of the finished article can be viewed, only the sheet providing the viewed surface need have a cosmetic appearance. The mold halves 1, 3 are closed toward each other so that the thermoplastic sheets 41, 43 and reinforcement material 33 are sandwiched in the mold plenum 35. Molding fluid is injected into the plenum 35, the molding fluid is cured and the composite molded article is removed from the mold.

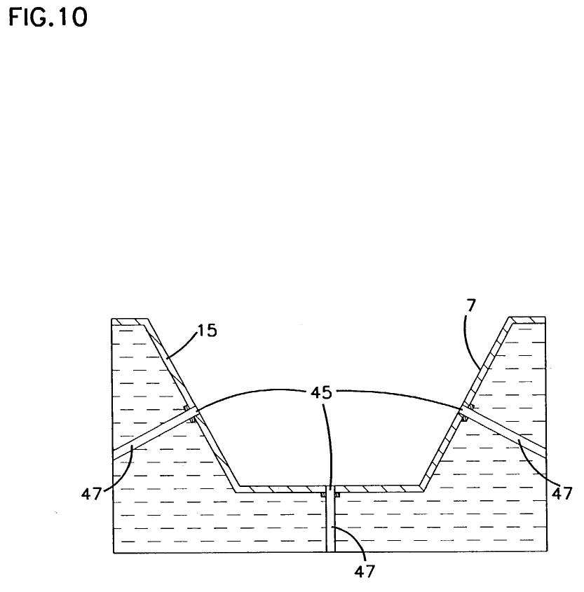

It may be advantageous to apply vacuum to the thermoplastic sheet after it is placed in the closed mold apparatus. Vacuum may hold the thermoplastic sheet in place on the mold membrane or may assist with thermoforming the thermoplastic sheet to the shape of the mold membrane. As shown in FIG. 10, vacuum ports 45 are formed in the mold membrane 15. The ports 45 are associated with vacuum lines 47 that are connected to a vacuum pump (not shown) or other vacuum source. The number and placement of vacuum ports 45 is not critical and may be varied based on their intended use. For example, fewer ports may be required to simply hold a shaped sheet in place whereas more ports may be required to thermoform the sheet. Also, vacuum ports may be provided in either or both mold membranes 13, 15.

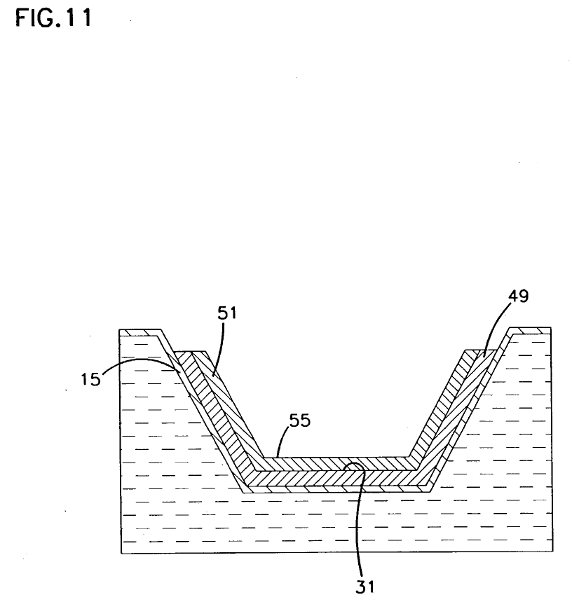

Referring to FIG. 11, a compressible, non-abrasive, soft liner 49 may be positioned on the mold membrane 15. A soft liner prevents marring of the cosmetic surface of the thermoplastic sheet from unevenness, burrs or accidental debris on the mold membrane 15 during molding of a composite article. The soft liner 49 may have a thickness of about 3 mm to about 25 mm and may be pre-formed to the shape of the mold. However, the soft liner 49 does not require pre-molding preparation if it readily conforms to the shape of the mold membrane 15. The soft liner 49 is pattern cut to fit the mold membrane 15 and bonded to the mold membrane 15 with an adhesive. The liner material may comprise a single material such as wool felt that is commercially available in a variety of suitable grades from USFELT, Sanford, Me. Also, a liner material having multiple layers including a foam rubber layer may be used. The rubber layer may be open or closed cell rubber comprising natural rubber, NEOPRENE, SBR, EDPM, polyethylene, polyurethane, NPVC, and EVA rubber material. A suitable multi-layer material is an open cell foam rubber having a plastic film adhered to one side and is commercially available from Griswold Rubber Co., Moosup, Conn. In the case of a multi-layer soft liner, the liner is preferably positioned so that the foam rubber layer is proximate the mold membrane and the plastic film is proximate the cosmetic surface of the thermoplastic sheet. A shaped thermoplastic sheet 51 having a cosmetically attractive surface 31 on at least one side is positioned on the soft liner 49 so that the cosmetically attractive surface 31 contacts the soft liner 49. Reinforcement material (not shown) may be placed on surface 55 of the thermoplastic sheet 51 opposed to the cosmetically attractive surface 31, the mold halves closed together to form a mold plenum and molding fluid injected into the plenum and cured to form the composite article. A soft liner may be used between the cosmetic surface of a thermoplastic sheet and the molding surface of either or both mold membranes 13, 15 without departing from the scope of the invention.

### WORKING EXAMPLES

Representative examples of making a composite according to the invention follows. An acrylic/ABS sheet having the dimensions 3.8 mm×1650 mm×2030 mm and sold under the trade designation DR/GX 3800 commercially available from Spartech Corp., Clayton, Mo., is mounted in a rotary style thermoforming apparatus. The acrylic surface is the cosmetic surface, and the sheet is thermoformed so that the acrylic surface is the exterior surface of the composite tub. The sheet is positioned in a pre-heating station and heated at temperatures ranging from about 320° F. to about 370° F. The sheet is heated until a proper forming temperature is achieved as indicated by the sheet beginning to sag. The sheet must be softened to obtain an initial preshape such that the preformed sheet can be placed in the mold without causing gaps, wrinkles or other surface flaws. A shape master mold heated to about 170° F. is brought in contact with the softened sheet and a vacuum is applied. The sheet is formed to the shape of the master mold. The shaped sheet is allowed to cool to room temperature and stiffen.

A closed mold apparatus available from VEC Technology Inc., Greenville, Pa. is used to make the composite article. The apparatus comprises opposed mold halves, each half having a rigid housing with a membrane attached. The membranes are shaped as male and female mold members so that a mold plenum is formed when the mold halves are brought together. The rigid housing and membrane of each mold half form a fluid tight chamber. The respective fluid chambers are filled with water as a backing fluid. The backing fluid supports the membrane to ensure proper dimensioning and enables temperature adjustments to regulate the cure rate of molding fluid.

The shape of the thermoplastic sheet conforms to the shape of the mold membranes so that the mold halves can be brought together to form the mold plenum. The temperature of the backing fluid in each mold half is adjusted to 150° F. The shaped thermoplastic sheet is placed in a mold half. About 17.6 pounds of fiberglass mat, is applied to the exposed surface of the thermoplastic sheet, that is, the surface of the sheet opposite the surface of the sheet in contact with the membrane. The mold halves are brought together to form the mold plenum.

A resin blend for forming a molding fluid is prepared according to the following compositions:

### Example 1

| | Parts by Weight |
|---|---|
| Vinyl ester resin | 100 |
| Cobalt mixed carboxylate (6% in mineral | 0.3 |
| spirits) | |
| N,N-di-me-p-toludine | 0 |
| Di-me-acetyl acetamide | 0 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0 |

Results:
Gel time 13′ 47″
Gel to Peak 21′ 15″
Peak Exotherm 220.8° F.

### Example 2

| | Parts by Weight |
|---|---|
| Vinyl ester resin | 100 |
| Cobalt mixed carboxylate (6% in mineral | 0.12 |
| spirits) | |
| N,N-di-me-p-toludine | 0 |
| Di-me-acetyl acetamide | 0.15 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.07 |

Results:
Gel time 45′ 24″
Gel to Peak 22′ 15″
Peak Exotherm 247.8° F.

### Example 3

| | Parts by Weight |
|---|---|
| Vinyl ester resin | 100 |
| Cobalt mixed carboxylate (6% in mineral | 0.1 |
| spirits) | |
| N,N-di-me-p-toludine | 0.1 |
| Di-me-acetyl acetamide | 0.15 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.07 |

Results:
Gel time 76′ 21″
Gel to Peak 45′ 36″
Peak Exotherm 186.8° F.

### Example 4

| | Parts by Weight |
|---|---|
| Vinyl ester resin | 100 |
| Cobalt mixed carboxylate (6% in mineral | 0.2 |
| spirits) | |
| N,N-di-me-p-toludine | 0.2 |
| Di-me-acetyl acetamide | 0 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.07 |

Results:
Gel time 22′ 12″
Gel to Peak 8′ 25″
Peak Exotherm 327.2° F.

### Example 5

| | Parts by Weight |
|---|---|
| Vinyl ester resin | 100 |
| Cobalt mixed carboxylate (6% in mineral | 0.1 |
| spirits) | |
| N,N-di-me-p-toludine | 0.2 |
| Di-me-acetyl acetamide | 0 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.07 |

Results:
Gel time 104′ 02″

### Example 6

| | Parts by Weight |
|---|---|
| Vinyl ester resin | 100 |
| Cobalt mixed carboxylate (6% in mineral | 0.2 |
| spirits) | |
| N,N-di-me-p-toludine | 0.1 |
| Di-me-acetyl acetamide | 0 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.07 |

Results:
Gel time 34′ 25″
Gel to Peak 20′ 22″
Peak Exotherm 242.1° F.

### Example 7

| | Parts by Weight |
|---|---|
| Vinyl ester resin | 100 |
| Cobalt mixed carboxylate (6% in mineral | 0.2 |
| spirits) | |
| N,N-di-me-p-toludine | 0.1 |
| Di-me-acetyl acetamide | 0 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.1 |

Results:
Gel time 35′ 23″
Gel to Peak 21′ 37″
Peak Exotherm 224.2° F.

### Example 8

| | Parts by Weight |
|---|---|
| Vinyl ester resin | 100 |
| Cobalt mixed carboxylate (6% in mineral | 0.2 |
| spirits) | |
| N,N-di-me-p-toludine | 0.1 |
| Di-me-acetyl acetamide | 0 |
| Mixed silicone wetting agent/deaerator | 0.5 |
| Vegetable Oil | 0.5 |
| Plastic microspheres | 0.5 |
| Al₂O₃(3H₂O) | 20 |
| Pigment (Black) | 0.2 |
| Pigment (White) | 0.75 |
| Styrene | 7 |
| t-bu-catechol | 0.1 |

Results:
Gel time 91′ 35″
Gel to Peak 30′+
Peak Exotherm Below 110° F.

### Example 9

| | WT.-% |
|---|---|
| Unsaturated polyester resin | 76 |
| Vinyl ester resin | 4 |
| Cobalt mixed carboxylate (6% in mineral | 0.2 |
| spirits) | |
| N,N-di-me-p-toludine | 0.6 |
| Di-me-acetyl acetamide | 0.15 |
| Mixed silicone wetting agent/deaerator | 0.8 |
| Vegetable Oil | 0.4 |
| Plastic microspheres | 0.4 |
| CaCO₃ | 16.4 |
| Pigment (Black) | 0.2 |
| Pigment (White) | 0.8 |
| Styrene | 0 |
| t-bu-catechol | 0.03 |

Molding fluid comprising resin blend, catalyst and about 0.001 pound of a flame retardant is heated in a reservoir to 82° F. The molding fluid is injected into the mold plenum to impregnate the fiberglass reinforcement material. The injection rate is about 190 inches-sec⁻¹ until full. The molding fluid is allowed to cure for about 60 minutes. A peak exotherm temperature of about 151° F. occurs at about 40 minutes (otherwise as noted). The mold halves are separated and the composite is allowed to air cool before being removed from the mold. After removing the composite from the mold, excess material may be trimmed from the edges and holes cut as needed to complete fabrication of the finished article.

While certain embodiments of the invention have been disclosed and described herein, it should be appreciated that the invention is susceptible of modification without departing from the spirit of the invention or the scope of the following claims.

We claim:

1. A method of making a molded article comprising the steps:
(a) placing in a spaced apart opposed relationship a first mold half comprising a first shaped mold membrane and a second mold half comprising a second shaped mold membrane wherein the first and second shaped mold membranes define a mold plenum when brought together to mold articles;
(b) placing a thermoplastic sheet in the mold plenum wherein the shape of the thermoplastic sheet substantially conforms to the shape of the mold membrane;
(c) placing reinforcement material in the mold plenum;
(d) closing the first and second mold halves such that the thermoplastic sheet and reinforcement material are contacted in the mold plenum;
(e) injecting molding fluid under pressure into the mold plenum; and
(f) curing the molding fluid.

2. A method according to claim 1 further comprising the step of placing a liner between the thermoplastic sheet and the mold membrane.

3. A method according to claim 2 wherein the liner is a felt or foam rubber material.

4. A method according to claim 3 wherein the foam rubber is open or closed cell rubber comprising natural rubber, butyl rubber, SBR, EDPM, polyurethane, NPVC, and EVA.

5. A method according to claim 1 wherein the thermoplastic sheet is placed in contact with the mold membrane and the reinforcing sheet is placed in contact with the thermoplastic sheet, in that order.

6. A method according to claim 1 wherein the thermoplastic sheet has a softening point of about 200° F. to about 400° F.

7. A method according to claim 1 wherein the thermoplastic sheet is in the form of a roll or a rectangular sheet.

8. A method according to claim 1 wherein the thermoplastic sheet is a laminate having two or more layers.

9. A method according to claim 8 wherein the thermoplastic sheet is a laminate comprising an acrylic layer and an acrylonitile-butadiene-styrene layer.

10. A method according to claim 9 wherein the acrylic layer has a cosmetically attractive exterior surface.

11. A method according to claim 1 wherein the thermoplastic sheet is selected from the group consisting of acrylonitile-butadiene-styrene, PVC, acrylonitrile-styrene-acrylate (ASA), acrylate-ethylene-styrene (AES), polystyrene, polycarbonate, nylon, polyacrylate, polymethacrylate, acrylate/methacrylate copolymer, polyethylene, polypropylene, and thermoplastic elastomer and elastomer blends.

12. A method according to claim 1 wherein the thermoplastic sheet has a thickness of 0.5 mm to 15 mm.

13. A method according to claim 1 wherein the molding fluid is a thermoset resin.

14. A method according to claim 13 wherein the thermoset resin is select from the group consisting of polyester, vinyl ester, acrylic polymer, polyepoxide, aminoplast, alkyd resin, polyamide, polyolefin, polyurethane, vinyl polymer, phenolic resin and mixtures thereof.

15. A method according to claim 1 wherein the temperature of the molding fluid is about 70° F. to about 150° F.

16. A method according to claim 1 wherein the reinforcement material is a woven or a non-woven fiber material.

17. A method according to claim 1 wherein the reinforcement material comprises natural or synthetic fiber material.

18. A method according to claim 17 wherein the natural fiber material comprises cotton, jute, flax and knaff.

19. A method according to claim 17 wherein the synthetic fiber material is selected from the group consisting of polyolefin, polyester, polyamide, fiberglass, carbon fiber, boron fiber and mixtures thereof.

20. A method according to claim 1 wherein the reinforcement material is placed in contact with the thermoplastic sheet before the sheet is placed in contact with the mold membrane.

21. A method according to claim 1 comprising the step of heating a backing fluid contained in the space between the mold membrane and a rigid housing to 80° F. to 200° F.

22. A method of making a molded article comprising the steps:
(a) placing in a spaced apart opposed relationship, a first mold half comprising a first mold membrane and a second mold half comprising a second mold membrane, wherein the first and second mold membranes define a mold plenum when brought together to mold articles;
(b) placing reinforcement material in contact with one of the first or second mold membranes;
(c) placing a thermoplastic sheet in contact with the reinforcement material wherein the thermoplastic sheet has a shape substantially conforming to the shape of the mold plenum;
(d) closing the first and second mold halves toward each other such that the thermoplastic sheet and reinforcement material are in contact in the mold plenum;
(e) injecting molding fluid under pressure into the mold plenum; and
(f) curing the molding fluid.

23. A method according to claim 22 further comprising the step of placing a liner between the thermoplastic sheet and the mold membrane.

24. A method according to claim 23 wherein the liner is a felt or foam rubber material.

25. A method according to claim 24 wherein the foam rubber is open or closed cell rubber comprising natural rubber, butyl rubber, SBR, EDPM, polyurethane, NPVC, and EVA.

26. A method according to claim 22 further comprising the step of shaping the thermoplastic sheet using thermoforming.

27. A method according to claim 1 wherein the thermoplastic sheet has a softening point of about 200° F. to about 400° F.

28. A method according to claim 1 wherein the thermoplastic sheet is in the form of a roll or a rectangular sheet.

29. A method according to claim 22 wherein the thermoplastic sheet is a laminate having two or more layers.

30. A method according to claim 29 wherein the thermoplastic sheet is a laminate comprising an acrylic layer and an ABS layer.

31. A method according to claim 30 wherein the acrylic layer has a cosmetically attractive exterior surface.

32. A method according to claim 22 wherein the thermoplastic sheet is selected from the group consisting of acrylonitile-butadiene-styrene, PVC, acrylonitrile-styrene-acrylate (ASA), acrylate-ethylene-styrene (AES), polystyrene, polycarbonate, nylon, polyacrylate, polymethacrylate, acrylate/methacrylate copolymer, polyethylene, polypropylene, and thermoplastic elastomer and elastomer blends.

33. A method according to claim 22 wherein the thermoplastic sheet has a thickness of 0.5 mm to 15 mm.

34. A method according to claim 22 wherein the molding fluid is a thermoset resin.

35. A method according to claim 34 wherein the thermoset resin is select from the group consisting of polyester, vinyl ester, acrylic polymer, polyepoxide, aminoplast, alkyd resin, polyamide, polyolefin, polyurethane, vinyl polymer and phenolic resin and mixtures thereof.

36. A method according to claim 22 wherein the temperature of the molding fluid is about 70° F. to about 150° F.

37. A method according to claim 22 wherein the reinforcement material is a woven or a non-woven fiber material.

38. A method according to claim 22 wherein the reinforcement material comprises natural or synthetic fiber material.

39. A method according to claim 38 wherein the natural fiber material comprises cotton, jute, flax and knaff.

40. A method according to claim 38 wherein the synthetic fiber material is selected from the group consisting of polyolefin, polyester, polyamide, fiberglass, carbon fiber, boron fiber and mixtures thereof.

41. A method according to claim 22 comprising the step of heating a backing fluid contained in the space between the mold membrane and a rigid housing to 80° F. to 200° F.

42. A method of making a molded article comprising the steps:
(a) placing a thermoplastic sheet into a first mold half wherein the mold half comprises a first shaped mold membrane;
(b) placing in a spaced apart opposed relationship the first mold half and sheet and a second mold half comprising a second shaped mold membrane wherein the first and second shaped mold membranes define a mold plenum when brought together to mold articles;
(c) closing the first and second mold halves such that the thermoplastic sheet is shaped in the mold plenum;
(d) opening the first and second mold halves;
(e) placing reinforcement material in contact with a surface of the shaped thermoplastic sheet;
(f) closing the first and second mold halves toward each other such that the thermoplastic sheet and reinforcement material are in contact in the mold plenum;
(g) injecting molding fluid under pressure into the mold plenum; and
(h) curing the molding fluid.

43. A method according to claim 42 further comprising the step of placing a liner between the thermoplastic sheet and the mold membrane.

44. A method according to claim 43 wherein the liner is a felt or foam rubber material.

45. A method according to claim 44 wherein the foam rubber is open or closed cell rubber comprising natural rubber, butyl rubber, SBR, EDPM, polyurethane, NPVC, and EVA rubber material.

46. A method according to claim 42 further comprising the step of shaping the thermoplastic sheet using thermoforming.

47. A method according to claim 42 wherein the thermoplastic sheet has a softening point of about 200° F. to about 400° F.

48. A method according to claim 42 wherein the thermoplastic sheet is in the form of a roll or a rectangular sheet.

49. A method according to claim 42 wherein the thermoplastic sheet is a laminate having two or more layers.

50. A method according to claim 49 wherein the thermoplastic sheet is a laminate comprising an acrylic layer and an acrylonitile-butadiene-styrene layer.

51. A method according to claim 50 wherein the acrylic layer has a cosmetically attractive exterior surface.

52. A method according to claim 42 wherein the thermoplastic sheet is selected from the group consisting of acrylonitile-butadiene-styrene, PVC, acrylonitrile-styrene-acrylate (ASA), acrylate-ethylene-styrene (AES), polystyrene, polycarbonate, nylon, polyacrylate, polymethacrylate, acrylate/methacrylate copolymer, polyethylene, polypropylene, and thermoplastic elastomer and elastomer blends.

53. A method according to claim 42 wherein the thermoplastic sheet has a thickness of 0.5 mm to 15 mm.

54. A method according to claim 42 wherein the molding fluid is a thermoset resin.

55. A method according to claim 54 wherein the thermoset resin is select from the group consisting of polyester, vinyl ester, acrylic polymer, polyepoxide, aminoplast, alkyd resin, polyamide, polyolefin, polyurethane, vinyl polymer, phenolic resin and mixtures thereof.

56. A method according to claim 42 wherein the temperature of the molding fluid is about 70° F. to about 150° F.

57. A method according to claim 42 wherein the reinforcement material is a woven or a non-woven fiber material.

58. A method according to claim 42 wherein the reinforcement material comprises natural or synthetic fiber material.

59. A method according to claim 58 wherein the natural fiber material comprises cotton, jute, flax and knaff.

60. A method according to claim 58 wherein the synthetic fiber material is selected from the group consisting of polyolefin, polyester, polyamide, fiberglass, carbon fiber, boron fiber and mixtures thereof.

61. A method according to claim 42 comprising the step of heating a backing fluid contained in the space between the mold membrane and a rigid housing to 80° F. to 200° F.

62. A method of making a molded article comprising the steps:
(a) placing a first thermoplastic sheet having a shape into a first mold half wherein the mold half comprises a first shaped mold membrane and the shape of the thermoplastic sheet substantially conforms to the shape of the mold membrane;
(b) placing reinforcement material in contact with a surface of the shaped thermoplastic sheet;
(c) placing a second thermoplastic sheet conforming to the shape of the first thermoplastic sheet in contact with the reinforcement material wherein the first thermoplastic sheet, the reinforcement material and the second thermoplastic sheet comprise a laminate;
(d) placing in a spaced apart opposed relationship the first mold half and the laminate, with a second mold half comprising a second shaped mold membrane wherein the first and second shaped mold membranes define a mold plenum when brought together to mold articles;
(e) closing the first and second mold halves toward each other such that the thermoplastic sheets and reinforcement material are sandwiched in the mold plenum;
(f) injecting molding fluid under pressure into the mold plenum; and
(g) curing the molding fluid.

63. A method according to claim 62 further comprising the step of placing a liner between the first thermoplastic sheet and the first mold membrane.

64. A method according to claim 63 wherein the liner is a felt or foam rubber material.

65. A method according to claim 64 wherein the foam rubber is open or closed cell rubber comprising natural rubber, butyl rubber, SBR, EDPM, polyurethane, NPVC, and EVA.

66. A method according to claim 62 further comprising the step of placing a soft liner between the second thermoplastic sheet and the second mold membrane.

67. A method according to claim 62 further comprising the step of shaping the first and second thermoplastic sheets using thermoforming.

68. A method according to claim 62 wherein the thermoplastic sheet has a softening point of about 200° F. to about 400° F.

69. A method according to claim 62 wherein the thermoplastic sheet is in the form of a roll or a rectangular sheet.

70. A method according to claim 62 wherein the thermoplastic sheet is a laminate having two or more layers.

71. method according to claim 70 wherein the thermoplastic sheet is a laminate comprising an acrylic layer and an acrylonitile-butadiene-styrene layer.

72. method according to claim 71 wherein the acrylic layer has a cosmetically attractive exterior surface.

73. A method according to claim 62 wherein the thermoplastic sheet is selected from the group consisting of acrylonitile-butadiene-styrene, PVC, acrylonitrile-styrene-acrylate (ASA), acrylate-ethylene-styrene (AES), polystyrene, polycarbonate, nylon, polyacrylate, polymethacrylate, acrylate/methacrylate copolymer, polyethylene, polypropylene, and thermoplastic elastomer and elastomer blends.

74. A method according to claim 62 wherein the thermoplastic sheet has a thickness of 0.5 mm to 15 mm.

75. A method according to claim 62 wherein the molding fluid is a thermoset resin.

76. A method according to claim 75 wherein the thermoset resin is select from the group consisting of polyester, vinyl ester, acrylic polymer, polyepoxide, aminoplast, alkyd resin, polyamide, polyolefin, polyurethane, vinyl polymer, phenolic resins and mixtures thereof.

77. A method according to claim 62 wherein the temperature of the molding fluid is about 70° F. to about 150° F.

78. A method according to claim 62 wherein the reinforcement material is a woven or a non-woven fiber material.

79. A method according to claim 62 wherein the reinforcement material comprises natural or synthetic fiber material.

80. A method according to claim 79 wherein the natural fiber material comprises cotton, jute, flax and knaff.

81. A method according to claim 79 wherein the synthetic fiber material is selected from the group consisting of polyolefin, polyester, polyamide, fiberglass, carbon fiber, boron fiber and mixtures thereof.

82. A method according to claim 1 wherein the molding fluid comprises:
(a) about 100 parts by weight of unsaturated polyester resin;
(b) about 0 to 100 parts of styrene per each 100 parts of (a);
(c) about 0.1 to 10 parts of a divalent metal salt catalyst per each 100 parts of (a);
(d) about 0.1 to 10 parts of a toulidine compound per each 100 parts of (a);
(e) about 0.1 to 10 parts of an acetylacetamide compound per each 100 parts of (a);
(f) about 0.1 to 10 parts of an alkyl catechol compound per each 100 parts of (a);
(g) about 5 to 50 parts of an inorganic filler per each 100 parts of (a);
(h) about 0.1 to 10 parts of plastic microspheres per each 100 parts of (a);
(i) about 0.1 to 10 parts of vegetable oil per each 100 parts of (a); and
(j) about 0.5 to 10 parts of pigment per each 100 parts of (a).
